(19) United States
(12) Patent Application Publication
(10) Pub. No.: US 2010/0242548 A1
(43) Pub. Date: Sep. 30, 2010

(54) SELF-ADVANCING ENCODER FOR APPLIANCE CONTROL

(75) Inventors: Matthew C. Webster, Glenview, IL (US); Thomas A. Mignone, Glenview, IL (US); Eric Larson, Glenview, IL (US)

Correspondence Address: ILLINOIS TOOL WORKS INC., 3600 WEST LAKE AVENUE, PATENT DEPARTMENT, GLENVIEW, IL, 60025, US

(73) Assignee: ILLINOIS TOOL WORKS INC., Glenview, IL (US)

(21) Appl. No.: 12/738,798

(22) PCT Filed: Nov. 7, 2008
(86) PCT No.: PCT/US08/82722

§ 371 Date: Apr. 19, 2010

Related U.S. Application Data
(60) Provisional application No. 60/988,927, filed on Nov. 19, 2007.

(51) Int. Cl. D06F 25/00; H01H 43/00

(52) U.S. Cl. 68/139; 200/37 R

(57) ABSTRACT

The present invention provides cycle control that may be used among many different appliances. The cycle control provides a standard knob on the shaft that may be rotated and pulled out or pushed into activate the washing machine. The shaft is attached to a high-resolution encoder and a motor allowing software control of the actual movement and cycle definitions provided by the control.

### CROSS-REFERENCE TO RELATED APPLICATIONS

This application claims priority to U.S. provisional application Ser. No. 60/988,927, filed Nov. 19, 2007, the entire contents of which are incorporated herein by reference.

### BACKGROUND OF THE INVENTION

The present invention relates generally to cycle controls for controlling appliances and, more specifically, to a universal cycle control providing identical hardware that can be used on a wide range of appliances.

Mechanical cycle controls are commonly used in household appliances. These cycle controls typically control operation of the appliance through a complex cam assembly and a series of cam followers. The cam assembly is typically rotated by a drive system such as an electric motor. The cam followers engage the cam surfaces as the cam assembly is rotated causing switch assemblies to trigger as each cam passes under a cam follower. The signals from these switch assemblies are, in turn, used to control an array of devices, such as relays, motors, and pumps that enable the function of the appliance.

As the number of features and cycles available on household appliances increase, the complexity of these mechanical cycle controls similarly increases. Each cycle typically involves multiple events. For example, a simple cycle on a washing machine may include the steps of (1) filling the tub for the wash cycle, (2) agitating the laundry, (3) draining the tub, (4) filling the tub for the rinse cycle, (5) agitating the laundry, (6) draining the tub, and (7) spin drying the laundry. The number of steps can be compounded by extra features, such as pre-wash, extra rinse, and multiple wash times for various soil levels. The number of steps is further multiplied by adding multiple cycles, such as regular wash, permanent press, gentle cycle, and the like. As a result, the number of cams, cam followers, and switches required to manage multiple cycles becomes increasingly complex.

Despite the internal complexity of these mechanical cycle controls, the timers are widely used on household appliances. This broad use is due in large part to a relatively simple user interface: a dial operator. The dial operator is typically used to rotate a shaft attached the cam assembly. By rotating the dial operator, the user is able to select the desired operating cycle. In addition, the dial operator and the associated markings around the operator provide visual feedback to the user as the appliance progresses through the steps of an operating cycle. Further, the dial operator can typically be pulled out and pushed in as a means for starting and stopping the appliance. Consumers have widely accepted these complex mechanical cycle controls primarily as a result of the relatively simple dial operator interface. Therefore, it is advantageous to maintain this familiar interface.

However, a drawback of the conventional mechanical cycle control is that each timer must be customized for the particular appliance on which it is to be installed. The series of cams, cam followers, and switches must correspond to the particular cycles and features of that appliance. Therefore, there is a need for an improved cycle control that does not rely on the complex system of cams and switches to control the appliance while maintaining the familiar appearance and operation of the dial operator. Preferably, this improved cycle control could be used on multiple appliances with varying cycles and features without changing the physical construction of the cycle control.

### SUMMARY OF THE INVENTION

The present invention provides a cycle control that may be used among many different appliances. The cycle control generates a rotational position signal that has a higher angular resolution than required for a given appliance so that it may be used in a variety of different appliance applications with different cycles. Lookup tables, with different data, in a controller, interpret the angular position into arbitrary cycles to control the motor and valves of the machine. Such a universal cycle control may be mass-produced to decrease costs and to simplify repairs. Further, the cycle control may be configured to interface with a dial operator, providing a familiar user interface to facilitate consumer acceptance of the new device.

In one embodiment of the invention, the appliance control includes a rotatable shaft having at least one set of rotational orientations corresponding to transitions between different steps within each cycle of the appliance and a rotary encoder communicating with the shaft to rotate therewith and providing a rotational position signal to indicate the absolute rotational orientation of the shaft at a higher angular resolution than required to detect the transitions between the different steps. An electric actuator coupled to the shaft provides rotation of the shaft among one of the sets of rotational orientations upon receipt of an electrical signal.

Thus, it is one feature of this invention to provide a rotary encoder with sufficient resolution to be used with a variety of different appliances having different cycles and cycle steps.

The shaft may be configured to move along an axis between a first position and a second position to activate an electric switch.

It is thus another feature of at least one embodiment of the invention to provide operation that mimics a conventional washing machine control.

The appliance control may include a controller receiving the rotational position signal and providing the electrical signal and executing a stored program to: (1) read the rotational position signal to determine a current step in the cycle of operation of the appliance according to a stored appliance look-up table; (2) operate an internal timer to time a predetermined interval; (3) at the conclusion of the predetermined interval output the electrical signal to move the shaft of the control a predetermined amount; and (4) repeat steps (1)-(3).

It is thus another feature of at least one embodiment of the invention to move the timing function of the appliance control to software providing greater flexibility. It is another feature of at least one embodiment of the invention to use a readily programmable lookup table to map controlled angular position to cycles allowing the control to be used with a variety of different washing machines.

The rotary encoder may include a circuit board adjacent to a shaft and a conductive wiper connected to the shaft to rotate therewith. A plurality of conductive pads may be circularly disposed around the circuit board wherein the plurality of conductive pads is individually electrically connected to the wiper to generate the rotational position signal.

It is thus a feature of at least one embodiment of the invention to provide a low-cost rotary encoder of arbitrary resolution.

A first resistor ladder having junctions between resistors that communicate with the conductive pads may produce a rotational position signal as a first voltage dependant on rotational position.

It is thus a feature of at least one embodiment of the invention to transmit a rotary position signal to a remote controller without the need for multiple wires each carrying a binary signal per standard convention.

A second resistor ladder having junctions between resistors may communicate with conductive pads different from the conductive pads communicating with the first resistor ladder to produce a second voltage dependant on rotational position, wherein the first and second voltage provide the rotational position signal in combination.

It is thus a feature of at least one embodiment of the invention to provide a greater angular resolution than may be readily obtained using a continuous resistor ladder.

The electric actuator may be a stepper motor and the electric signal is a set of phased electrical pulses.

It is thus a feature of at least one embodiment of the invention to provide for a motor that naturally provides detents in rotation.

These and other features, advantages, and features of the invention will become apparent to those skilled in the art from the detailed description and the accompanying drawings.

### BRIEF DESCRIPTION OF THE DRAWINGS

Preferred exemplary embodiments of the invention are illustrated in the accompanying drawings in which like reference numerals represent like parts throughout, and in which:

FIG. 1 is an exemplary application of the cycle control of the present invention illustrated in a simplified representation of a washing machine;

FIG. 2 is a block diagram illustrating a control system incorporating the cycle control of the present invention;

FIG. 3 is a front isometric view of one embodiment of the cycle control;

FIG. 4 is a rear isometric view of the cycle control of FIG. 2; and

FIG. 5 is an exploded perspective view of the cycle control of FIG. 2.

### DETAILED DESCRIPTION OF THE INVENTION

The present invention provides a universal cycle timing system that may be used among many different appliances. In a preferred embodiment of the invention, as illustrated in FIG. 1, the cycle control 16 is used in a washing machine 10. It is contemplated that the cycle control 16 may be used in other household appliances that use similar timing systems, including but not limited to a clothes dryer and a dishwasher.

Referring to FIG. 1, an exemplary application of the cycle timing system illustrates a washing machine 10 providing a housing 12 having a console portion 14 displaying various controls and indicators including a cycle control 16 and indicator lights 18. The cycle control 16 preferably engages a dial operator 20 having a handle portion 22 graspable by a user and an indicator portion 24 indicating the relative rotational position of the operator 20. The indicator portion 24 provides visual identification to the user of the present operating mode of the washing machine 10 according to the cycle markings 26 on the washing machine 10.

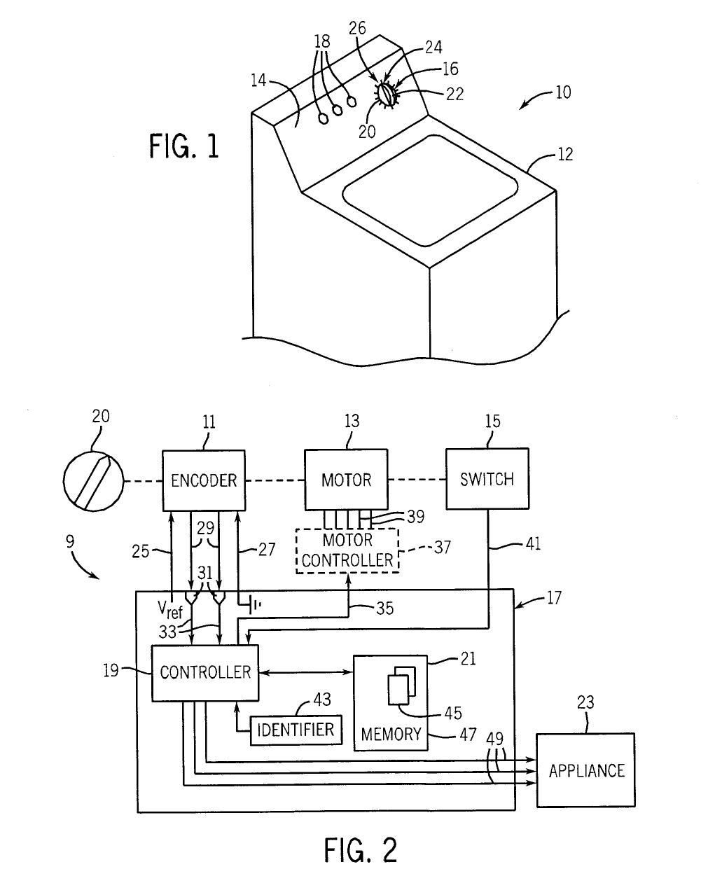

Referring next to FIG. 2, a block diagram illustrates an exemplary control system 9 incorporating the cycle control of the present invention. A dial operator 20 interacts with the encoder 11, motor 13, and the switch 15 in the control system 9. The encoder 11, motor 13, and switch 15 are illustrated schematically to identify electrical signals between each of the devices and a controller 19 in the system 9. The encoder 11 receives a reference voltage signal 25 and a common voltage reference 27 from the circuit board 17 on which the controller 19 is mounted. The encoder 11 returns at least one and preferably two analog voltages 29 which are dependent on the rotational position of the encoder 11. The analog voltages 29 are converted by analog to digital converters 31 and provide input signals 33 to the controller 19 which identify the rotational position of the encoder 13. The controller 19 further issues commands 35 to the motor 13. Typically these commands 35 will be in the form of a desired position of the motor 13 which is interpreted by a motor controller 37 which, in turn, generates the required electrical pulses 39 to rotate the motor 13. The controller 19 further receives a signal 41 from a switch 15 used to start and stop operation of the control system 9.

The controller 19 includes a program which executes on the controller 19. The program either contains knowledge of or an external identifier 43 may be provided, such as DIP switches or a selection resistor, to provide an indication of the appliance 23 on which the control system 9 is to be installed. The controller 19 uses this identification of the appliance 23 to access a look-up table 45 from memory 47. The look-up table 45 contains information regarding the specific appliance 23 to be controlled. The appliance information in the look-up table 45 may include, but is not limited to, data such as the cycles of operation, the steps within each cycle, the rotational position that corresponds to each step of a cycle, the amount of time each step takes to execute, and the actuators used by the appliance 23. The controller 19 uses the rotational position signals 33 from the encoder 11 to identify the desired step of execution within a cycle based on information from the look-up table 45. The controller 19 then sends electrical signals 49 to different actuators within the appliance 23 based on the desired step of a cycle. For example, if the control system 9 is installed on the washing machine 10 of FIG. 1, these electrical signals 49 may control devices such as valves for controlling flow of water into and out of a washtub or a motor for driving the washing machine agitator or for spinning the washtub.

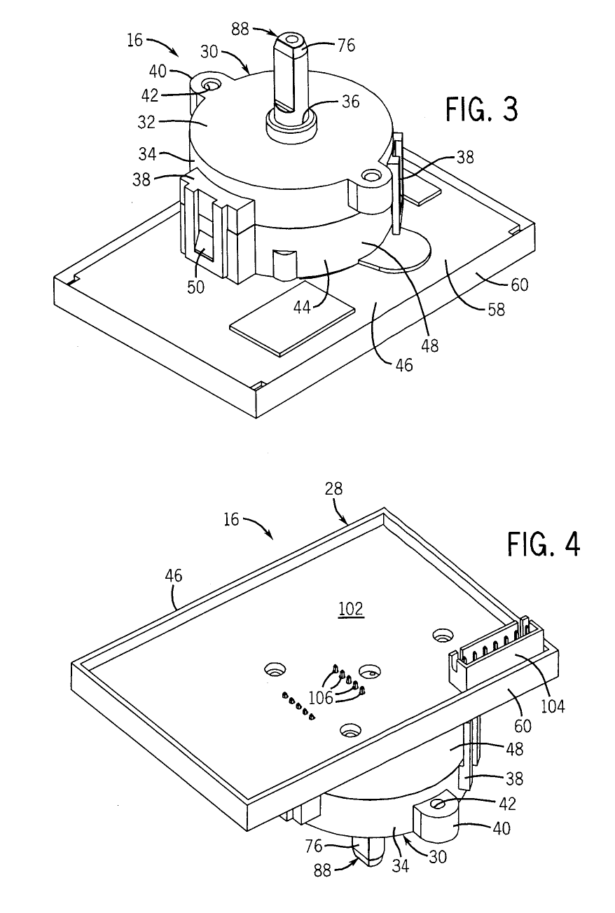

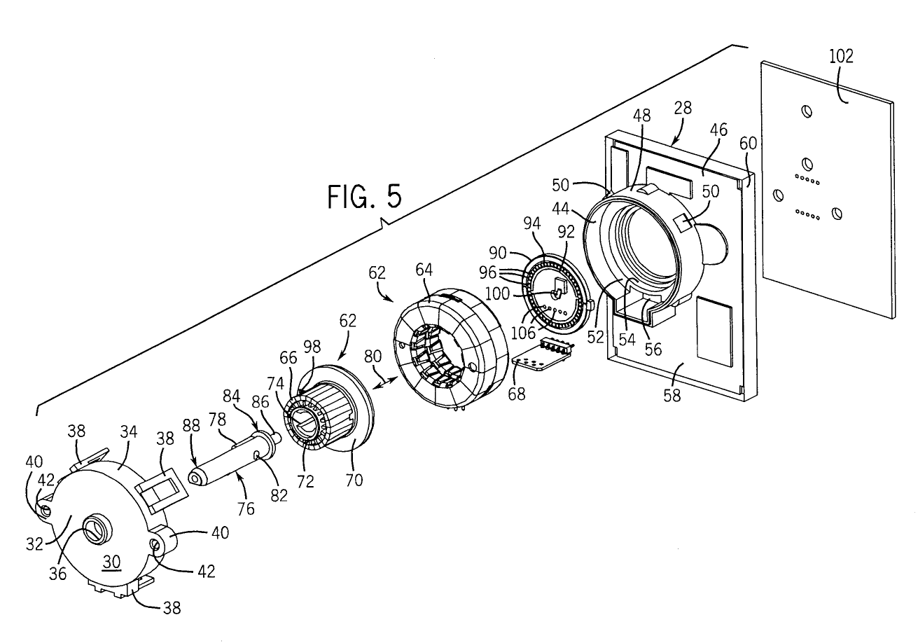

Referring now to FIGS. 3-5, the cycle control 16 preferably includes a rear housing 28 and a front housing 30 removably engaged with the rear housing 28. The front housing 30 preferably includes an upper surface 32 with a side surface 34 extending generally perpendicular to the upper surface 32. The upper surface 32 is generally round with a hole 36 extending through the center of the upper surface 32. At least one clip 38, and preferably multiple clips 38 are incrementally positioned along the side surface 34 and extend generally parallel from the side surface 34. At least one tab 40, and preferably a pair of tabs 40 positioned on opposite sides of the upper surface 32, are connected to the upper surface 32 and have an aperture 42 therein to provide a means for mounting the cycle control 16 to the appliance.

The rear housing 28 preferably includes a generally round portion 44, which engages the front housing 30, and a generally rectangular portion 46 extending behind the round portion 44. The round portion 44 includes a side surface 48 and at least one tab 50 mounted on the side surface 48. Each tab 50 corresponds and is positioned to engage a clip 38 from the front housing 30. The round portion 44 further includes an annular seat 52, extending around the periphery of the rear of the round portion 44, and a first aperture 54, defined by the periphery of the seat 52 and in communication with the interior of the rectangular portion 46. A second aperture 56 is positioned below the seat 52 and is generally rectangular. The second aperture 56 is similarly in communication with the interior of the rectangular portion 46. The side surface 48 of the round portion 44 is mounted on a top surface 58 of the rectangular portion 46. The rectangular portion 46 also has a side surface 60 extending generally perpendicular from the top surface 58.

The cycle control 16 further includes an electric motor 62, preferably a stepper motor. The electric motor 62 preferably includes a stator 64, a rotor 66, and a connector board 68. The electric motor 62 is mounted to and at least partially contained by the rear housing 28. The connector board 68 is attached to the bottom of the stator 64 and extends through the second aperture 56. The motor 62 preferably includes an annular plate 70 affixed to the rear of the rotor 66 such that it rotates with the rotor 66. The diameter of the plate 70 is preferably less than the diameter of the stator 64. The rotor 66 includes an aperture 72 extending therethrough. Preferably, the aperture 72 further includes a slot 74 extending thorough the aperture 72 configured to receive a key portion 78 of a keyed shaft 76 and to engage the shaft 76 for rotation.

The shaft 76 may be moved inward to a first position or outward to a second position along the axis 80 of the shaft 76. The shaft 76 includes an interior, spring-biased pin 82 to selectively retain the shaft 76 in either the first or the second position. The rear end 84 of the shaft 76 further includes a plunger 86 affixed to, and protruding axially from, the end of the shaft 76. The front end 88 of the shaft 76 extends through the hole 36 in the front housing 30 and is configured to receive a dial operator 20.

The cycle control 16 further includes a generally round circuit board 90 preferably retained behind the seat 52 in the round portion 44 of the rear housing 28 and oriented generally parallel to the motor 62. A preferred embodiment of the circuit board 90 includes a first annular trace 92 and a second annular trace 94 concentrically disposed on the board 90. The circuit board 90 further includes five connecting pins 106. One of the connecting pins 106 provides a common voltage level to the first trace 92, and a second connecting pin 106 provides a voltage reference level to the second trace 94.

The second trace 94 further includes a series of pads 96 incrementally positioned along the trace 94. The number of pads 96 corresponds to the number of steps available in the stepper motor 62. Preferably the stepper motor 62 has forty-eight steps, but the stepper motor 62 may have any number of steps such that the incremental change in the rotational position signal has sufficient resolution to identify each mode of operation of the appliance. The first and second traces, 92 and 94, are aligned on the circuit board 90 such that a wiper 98 affixed to the rear of the plate 70 mounted on the rotor 66 can simultaneously engage both traces. Two of the connecting pins 106 provide the rotational position signal corresponding to the position of the wiper 98.

The circuit board 90 further includes a lever switch 100. The lever switch 100 is aligned with the plunger 86 and is toggled on and off as the shaft 76 is moved in and out. The fifth connecting pin 106 provides the electrical signal generated by the lever switch 100.

A rectangular circuit board 102 is mounted within the rectangular portion 46 of the rear housing 28. The rectangular circuit board 102 interfaces with the connector board 68 of the motor 62 and with the connecting pins 106 on the round circuit board 90. The rectangular circuit board 102 further includes an external connector block 104 for interfacing with an external microcontroller or for providing control signals to actuators within the appliance. Preferably, a motor control chip, not shown, mounted on the rectangular circuit board 102 provides voltages to the stator 64 through the connector board 68 in response to command signals input from the external connector block 104. Alternatively, stator voltages may be generated externally and passed directly from the external connector block 104 through to the connector board 68.

Similarly, a microcontroller or other programmable logic device, as is known in the art, is preferably mounted on the rectangular circuit board 102 to process the rotational position signal from the connecting pins 106 and format the signal to be output through the external connector block 104 for use by an external microcontroller. Alternatively, the rotational position signal may pass directly from the connecting pins 106 to the external connector block 104.

In operation, the cycle control 16 is mounted in an appliance, such as the washing machine 10 illustrated in the exemplary application in FIG. 1. Preferably, a dial operator 20 is mounted on the front end 88 of the shaft 76 to facilitate the user interface. Alternatively, a knob, colored line on the shaft, or any other means of indicating the rotational orientation of the shaft to the user may be used. The user may grasp the handle portion 22 of the dial operator 20 either to adjust the rotational orientation of the shaft 76 or to push and pull the shaft 76 between the first and second positions. Under typical operation, a user first rotates the shaft 76 to the start of the desired operating cycle and then either pushes in or pulls out the shaft 76 to begin operation of the appliance.

As the appliance is running, the electric motor 62, and preferably a stepper motor, rotates the shaft 76 in cooperation with the cycle of operation. The stepper motor 62 may be easily rotated using the operator 20 when no power is applied to the stepper motor 62. Further, the stepper motor 62 may be easily overhauled by a user while power is applied to the motor 62 if the user wishes to change the cycle of operation. The permanent magnet rotor 66 of the stepper motor 62 provides magnetic detent positions as a result of the natural magnetic attraction between the rotor 66 and stator 64 for tactile feedback to the user. The stepper motor 62 may be substituted with a DC gear motor or the like, the latter providing a slip clutch or the like allowing free rotation of the shaft 76 when power is not applied.

The rotation of the rotor 66 simultaneously causes the slot 74 in the aperture 72 and the plate 70 affixed to the rear of the rotor 66 to turn. The slot 74 engages the key portion 78 of the shaft 76 resulting in rotation of the shaft 76, and the plate 70 causes the wiper 98 to move in an arcuate path. As a result, the rotational orientation of the shaft 76 corresponds to the position of the wiper 98.

Preferably, the wiper 98 engages the circuit board 90 to generate the rotational position signal. The wiper 98 is oriented to continuously engage the first trace 92 and selectively engage pads 96 on the second trace 94. The first trace 92 is held at an electrical common voltage level. The second trace 94 has an electrical reference voltage applied at one end of the trace 94. Preferably, the second trace 94 is resistive in nature such that a voltage divider network is created between each of the pads 96. Alternatively, other methods may be used to establish the voltage divider such as surface mount resistors placed between each pad 96. As the wiper 98 engages each pad 96 along the second trace 94, an electrical circuit is established, consisting of: the reference voltage input at one end of the second trace, a variable resistance between the input pin and the pad 96 presently engaged by the wiper 98, and the common voltage level present in the first trace. The resulting rotational position signal is an analog voltage which varies between the common voltage level and the reference voltage level according to the resistance value at each pad 96 along the second trace. Preferably, the second trace 94 is further divided into two segments, each segment representing one half of the rotational movement of the shaft 76. Each segment includes a complete voltage divider network and a corresponding analog voltage output. Alternatively, the second trace could be a continuous trace or any number of segments such that suitable angular position resolution, as would be known to one skilled in the art, is provided. The preceding description describes one embodiment of a rotational position feedback device, but it is contemplated that any means known to one skilled in the art could be used to generate the rotational position. For example, a light emitting diode with photoreceptors could be used in place of the resistive network, or discrete input signals could be generated to represent the rotational position rather than analog voltages. Other variations and modifications of the encoder are similarly within the scope of the present invention.

As still another aspect of at least one embodiment of the invention, the electric motor 62 is preferably controlled by an external microcontroller. Alternatively, the microcontroller could be included on the second circuit board. The microcontroller is programmed to control operation of the appliance.

The microcontroller may include an internal program to operate the cycle control 16 in a closed loop fashion, for example, accepting a rotational command and moving the stepper motor 62 to provide a reading on the encoder matching the rotational command. The microcontroller may move the stepper motor 62 in either direction, for example, to provide the shortest rotational path to a desired rotational position by providing voltages to the stator 64 through the connector board 68. The microcontroller may also monitor movement of the encoder initiated by the user through manual rotation of the operator 20 without activation of the motor 62 and adjust operation of the appliance accordingly. The rotational position signal is input to the microcontroller to indicate the desired cycle of operation, and the program in the microcontroller controls operation of the appliance according to the selected cycle. The signal from the switch 100 is similarly input to the microcontroller to indicate when the appliance is to start or stop. By providing different programs within the microcontroller, the same cycle control may be used on multiple appliances, each appliance having a different set of cycles.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. An appliance control for indicating different steps in at least one cycle of operation of the appliance, the appliance control comprising:
a rotatable shaft having at least one set of rotational orientations corresponding to transitions between different steps within each cycle of the appliance;
a rotary encoder communicating with the shaft to rotate therewith and providing a rotational position signal to indicate an absolute rotational orientation of the shaft at a higher angular resolution than required to detect the transitions between the different steps; and
an electric actuator coupled to the shaft to provide rotation of the shaft among rotational orientations upon receipt of an electrical signal.

2. The appliance control of claim 1 wherein the shaft is configured to move along an axis between a first position and a second position further comprising an electric switch activated by the shaft moving between the first and second positions.

3. The appliance control of claim 2 further including a controller receiving the rotational position signal and providing the electrical signal and executing a stored program to:
(1) read the rotational position signal to determine a current step in the cycle of operation of the appliance according to a stored appliance look-up table;
(2) operate an internal timer to time a predetermined interval;
(3) at a conclusion of the predetermined interval, output the electrical signal to move the shaft of the control a predetermined amount; and
(4) repeat steps (1)-(3).

4. The appliance control of claim 3 wherein the look-up table defines each of the different steps of the cycle of operation of the appliance in terms of a range of the rotational position signal;
whereby a control may be flexibly reprogrammed for different appliances without hardware modification.

5. The appliance control of claim 3 wherein the look-up table defines the predetermined interval for each stage.

6. The appliance control of claim 1 wherein the rotary encoder further comprises:
a circuit board adjacent to the shaft;
a conductive wiper connected to the shaft to rotate therewith; and
a plurality of conductive pads circularly disposed around the circuit board wherein the plurality of conductive pads are individually electrically connected to the wiper to generate the rotational position signal.

7. The appliance control of claim 6 further comprising:
a first resistor ladder having junctions between resistors communicating with the conductive pads to produce a rotational position signal that is a first voltage dependant on rotational position.

8. The appliance control of claim 7 further comprising:
a second resistor ladder having junctions between resistors communicating with conductive pads different from the conductive pads communicating with the first resistor ladder to produce a second voltage dependant on rotational position, wherein the first and second voltage provide the rotational position signal.

9. The appliance control of claim 2 further comprising:
a dial operator connected to the shaft for manual adjustment of the rotational orientation and axial position of the shaft; and
at least one set of cycle markings wherein the dial operator includes an indicator portion operative with the cycle markings to identify a relative point of operation within each of the cycles for the appliance.

10. The appliance control of claim 1 wherein the electric actuator is a stepper motor and the electric signal is a set of phased electrical pulses.

11. A washing machine comprising:
at least one valve for controlling a flow of water to a washtub and a motor for agitating and spinning contents of the washtub during different steps of different cycles of the washing machine;
an appliance control for indicating different steps in the different cycles of operation of the appliance and comprising:
(1) a rotatable shaft having a set of rotational orientations corresponding to transitions between different steps within each cycle of the appliance;
(2) a rotary encoder communicating with the shaft to rotate therewith and providing a rotational position signal indicating the rotational orientation of the shaft, the rotational position signal distinguishing among each cycle and each step within each cycle; and
(3) an electric actuator coupled to the shaft to provide rotation of the shaft among the rotational orientations upon receipt of an electrical signal.
a controller receiving the rotational position signal and providing the electrical signal and executing a stored program to:
(1) read the rotational position signal to determine a current step in the cycle of operation of the appliance according to a stored appliance look-up table and to control operation of the valve and motor according to the current step;
(2) operate an internal timer to time a predetermined interval;
(3) at a conclusion of the predetermined interval output the electrical signal to move the shaft of the control a predetermined amount; and
(4) repeat steps (1)-(3).

12. The washing machine of claim 11 wherein the shaft is configured to move along an axis between a retracted position and an extended position further comprising an electric switch activated by the shaft moving between the extended and retracted positions, the output of the electric switch communicating with the controller to stop water flow through the valve and motion of the motor when the shaft is extended.

13. The appliance control of claim 11 wherein the look-up table defines each of the different steps of the cycle of operation of the appliance in terms of a range of the rotational position signal;
whereby a control may be flexibly reprogrammed for different appliances without hardware modification.

14. The appliance control of claim 11 wherein the look-up table defines the predetermined interval for each stage.

15. The washing machine of claim 11 wherein the rotary encoder further comprises:
a circuit board adjacent to shaft;
a conductive wiper connected to the shaft to rotate therewith; and
a plurality of conductive pads circularly disposed around the circuit board wherein the plurality of conductive pads are individually electrically connected to the wiper to generate the rotational position signal.

16. The appliance control of claim 15 further comprising:
a first resistor ladder having junctions between resistors communicating with the conductive pads to produce a rotational position signal that is a first voltage dependant on rotational position and wherein the controller includes an analog to digital converter to convert the analog signal into a digital word for processing by the stored program.

17. The appliance control of claim 16 further comprising:
a second resistor ladder having junctions between resistors communicating with the conductive pads different from the conductive pads communicating with the first resistor ladder to produce a second voltage dependant on rotational position, wherein the controller includes a first and second analog to digital converter to convert the first and second voltages to provide the rotational position signal to in the controller.

18. The appliance control of claim 12 further comprising:
a dial operator connected to the shaft for manual adjustment of the rotational orientation and axial position of the shaft; and
at least one set of cycle markings wherein the dial operator includes an indicator portion operative with the cycle markings to identify a relative point of operation within each of the cycles for the appliance.

19. The appliance control of claim 11 wherein the electric actuator is a stepper motor and the electric signal is a set of phased electrical pulses.
